(19) United States
(12) Patent Application Publication
(10) Pub. No.: US 2008/0235216 A1
(43) Pub. Date: Sep. 25, 2008

(54) METHOD OF PREDICITNG AFFINITY BETWEEN ENTITIES

(76) Inventor: Steven E. Ruttenberg, Tarzana, CA (US)

Correspondence Address: SCHOX PLC, 730 Florida Street #2, San Francisco, CA, 94110, US

(21) Appl. No.: 12/054,350

(22) Filed: Mar. 24, 2008

Related U.S. Application Data
(60) Provisional application No. 60/896,561, filed on Mar. 23, 2007.
(60) Provisional application No. 60/941,260, filed on May 31, 2007.
(60) Provisional application No. 61/012,438, filed on Dec. 9, 2007.

(51) Int. Cl. G06F 17/30; G06F 7/10

(52) U.S. Cl. 707/5; 707/E17.014

(57) ABSTRACT

In one embodiment, the invention includes a method of predicting affinity between a first entity and a second entity including associating a first plurality of characteristic tags with the first entity. The first plurality of characteristic tags are preferably associated with a first reference entity, generating a comparison matrix, and calculating a similarity score between the first entity and the second entity using the comparison matrix, wherein the second entity is associated with a second plurality of characteristic tags. In another embodiment, the invention includes a method of relating characteristic tags, including selecting a first characteristic tag from a first plurality of characteristic tags, selecting a second characteristic tag from a second plurality of characteristic tags, and relating the first characteristic tag and the second characteristic tag.

### CROSS-REFERENCE TO RELATED APPLICATIONS

This application claims the benefit of U.S. Provisional Application number 60/896,561 filed 23 Mar. 2007, of U.S. Provisional Application number 60/941,260 filed 31 MAY 2007, and of US Provisional Application number 61/012,438 filed 9 Dec. 2007, which are all three incorporated in their entirety by this reference.

### TECHNICAL FIELD

This invention relates generally to the information-processing field, and more specifically to a new and useful method of predicting affinity between entities in the information-processing field.

### BRIEF DESCRIPTION OF THE FIGURES

FIG. 1 is a flowchart representation of a first preferred method.

FIG. 2 is an example flowchart of the generation of an entity characteristic tag list, in this example a weighted user characteristic tag list.

FIG. 3 is a sample user interface for choosing a reference entity, where the reference entity is group.

FIG. 4 is a sample user interface for assigning weights to characteristic tags associated with an entity.

FIG. 5 is an entity comparison value matrix using two different pluralities of entities.

FIG. 6 is an entity comparison value matrix using the same plurality of entities.

FIG. 7 is a sample calculation of entity similarity using a matrix of tag comparison scores.

FIG. 8 is an example calculation of entity (in this case the entity is a user) similarity using a matrix of comparison scores of associated entities (such as groups).

FIG. 9 is a flowchart example of the tag lists of a plurality of associated entities contributing to an entity (such as a user) tag list.

FIG. 10 is a flowchart representation of generating a color representation for a first entity according to a second preferred method.

FIG. 11 is pair of example color representations generated by the second preferred method.

FIG. 12 is a flowchart representation of a method of relating characteristic tags according to a third preferred method.

FIG. 13 is a sample user interface for assigning values descriptive of the relatedness of one characteristic tag to another characteristic tag.

FIG. 14 is a sample flowchart for merging and ranking tags.

FIG. 15 is a sample user interface for merging tags.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

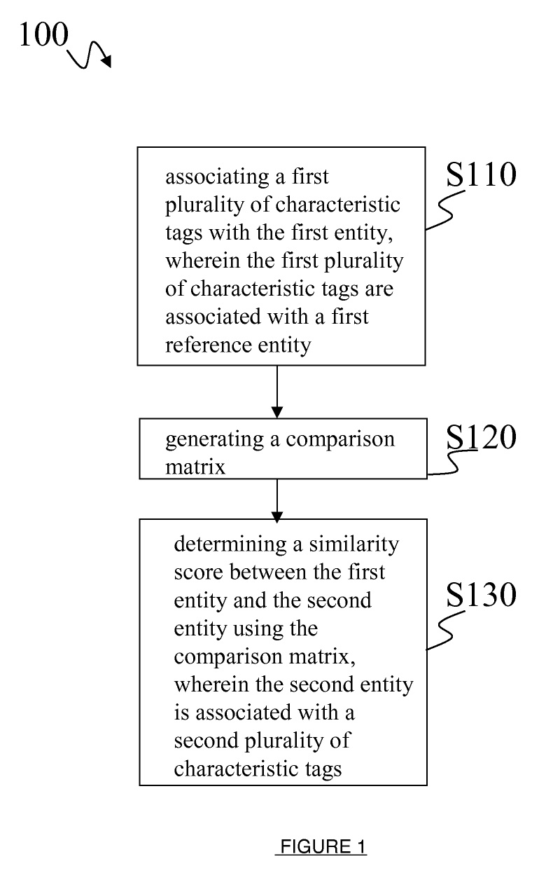

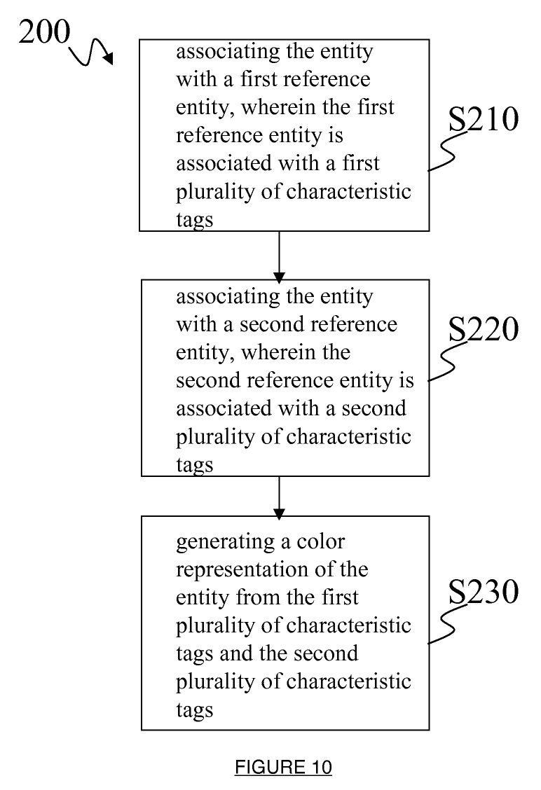

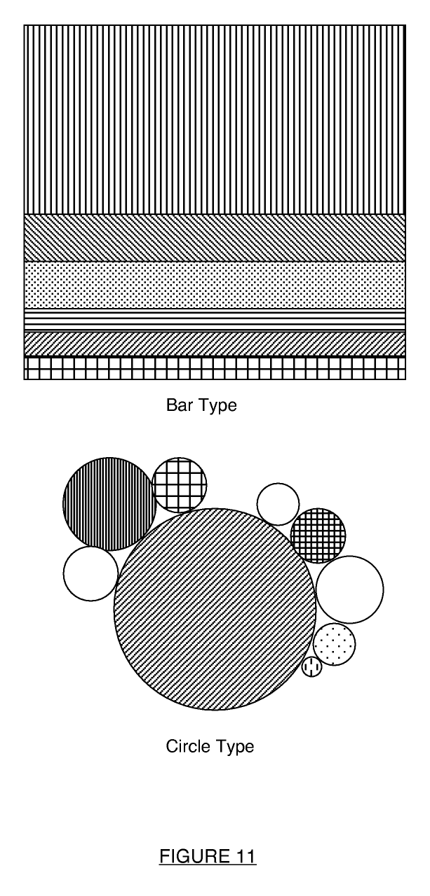

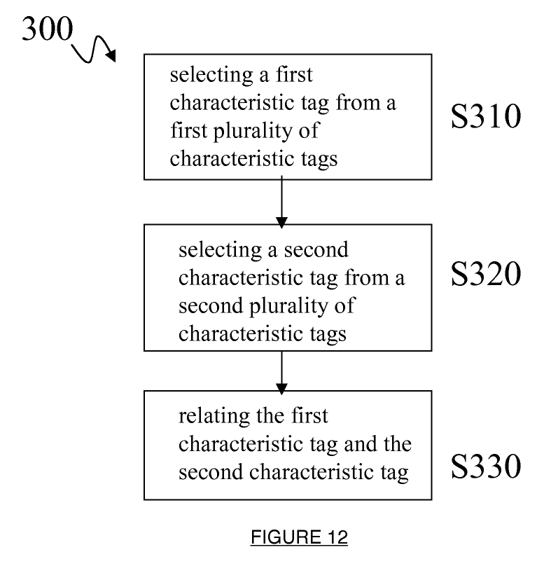

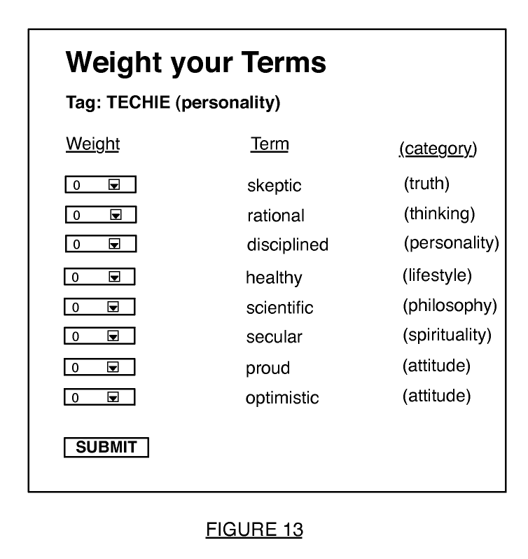

In the first preferred method, as shown in FIGS. 1-9, the invention includes a method 100 of predicting affinity between a first entity and a second entity. In the second preferred method, as shown in FIGS. 10-11, the invention includes a method 200 of generating a color representation of an entity. In the third preferred method, as shown in FIGS. 12-15, the invention includes a method 300 of relating characteristic tags.

### 1. Method of Predicting Affinity Between a First Entity and a Second Entity

As shown in FIGS. 1-9, a first preferred embodiment of the invention includes a method 100 of predicting affinity between a first entity and a second entity. The method 100 of predicting affinity between a first entity and a second entity includes associating a first plurality of characteristic tags (which are associated with a first reference entity) with the first entity S110, generating a comparison matrix S120, and calculating a similarity score between the first entity and the second entity (which is associated with a second plurality of characteristic tags) using the comparison matrix S130. The method 100 preferably predicts an affinity between entities, preferably for recommendations of other entities, such as users, groups, products, and any other suitable entity that have a high (or low) degree of affinity with the entity seeking a recommendation. In the most preferred embodiment, the method is used to predict affinity between a user and a group, a user and a user, and/or a group and a group.

Entities are preferably any object that can be described by characteristic tags and are associable with another object, more preferably an entity is a user, group (of users or other entities), item, product, media, event, location, service or information such as music, film, book, activity, advertisement, travel destination, party, vocation, job, team, political group, religion, idea, website, article, news item, game, and/or any other suitable object.

Characteristic tags are preferably keywords that are descriptive of the entity or of other entities affiliated with the entity. The characteristic tags are preferably keywords, more preferably adjectives, but may be any form of descriptive word, symbols or images that help to classify the characteristics of the entity. The characteristic tags preferably describe characteristics of users (such as fans, aficionados, supporters, adherents, constituents, etc.) who feel an affinity with a group and/or members of the group, and/or issues important to the group, attitudes, values, beliefs or personality traits of members belonging to the group, features of the group, or any other suitable subject matter that is relevant to the group, and which may have value as keywords for searching, indexing, and/or functional matching. The characteristic tags are preferably not limited to a single language and may be in any number of languages. The characteristic tags may also be used for negative descriptions, to exclude certain attitudes, values, beliefs or personality traits from a group, and/or to highlight descriptions that members or users who feel affinity are not likely to identify with (thus improving the definition of the group). As an example, consider a group called “The Seattle Vegetarian Society”. The characteristic tags might include: vegetarian, vegan, ethical, empathetic, spiritual, healthy, loves animals. Negative characteristic tags might include: carnivore and hunter.

The reference entity is preferably a group. A group is preferably created and defined by a user and preferably represents an organization, club or group, more preferably an organization, club or group focused on a particular topic, interest or concern. Preferably, groups attract users that tend to share similar attitudes, values, beliefs or personality traits, and are usually organized around common interests or concerns. The reference entity may alternatively be any entity associated with characteristic tags that define interests, affinities, identification, attitudes, values, beliefs, personality, and may be items, products, media, events, locations, services or information such as music, movies, books, activities, ads, travel destinations, parties, vocations, jobs, teams, politics, religion, ideas, websites, articles, news items, games, or any other suitable entity. The reference entities may be internal or accessible remotely, preferably over the Internet through an Application Programming Interface (API).

1.1 Associating a First Plurality of Characteristic Tags with the First Entity

Step S110, which recites associating a first plurality of characteristic tags with the first entity, preferably functions to copy the association of characteristic tags from a reference entity to another entity. This copying of the association of characteristic tags from a reference entity is preferably performed at least once at the creation of a new entity, and may also be performed on/by an existing entity. The copying of the association of characteristic tags from a reference entity to the first entity may have a weighting factor assigned to all characteristic tags associations that are copied from the reference entity, and/or each individual characteristic tag may have an individual weighting factor assigned to it.

In a first variation of step S110, the first entity is a user, and the reference entity is a group. A user preferably selects a group that the user feels an affinity with, and the user entity becomes associated with the same characteristic tags associated with the group. In a second variation of Step S110, the first entity is a user and the reference entity is another user. A user preferably selects another user that the user feels an affinity with, and the user entity becomes associated with the same characteristic tags associated with the other user. In a third variation of Step S110, the first entity is a group and the reference entity is also a group. A group that has an affinity with another group may reflect that affinity to the other group by associating itself with the characteristic tags of the reference group. In a fourth variation Step S110 preferably includes creating a new entity to use as the first entity and selecting a first reference entity. Preferably the new entity is a user, but may alternatively be a group or any other suitable entity.

In a fifth variation, Step S110 includes associating a user with the characteristic tags of at least one reference entity, wherein the association is due to a user joining a group, purchasing or viewing products, services or media, browsing a group or any other suitable activity that references a reference entity. Membership/purchase/viewing is a type of declared affinity or identification. Preferably, any entity with an observed interest, affinity, identification, association with other entities may define itself through the pooled definition (preferably the weighted characteristic tag lists) of those other entities.

In a sixth variation, a user's expressed affinity for entities of a specific domain (a domain may be any plurality of entities that shares some common aspect) generates a domain-specific weighted characteristic tag list for the user. Preferably, the list of weighted characteristic tags for each preferred entity in a domain (for example, favorite movies, or closest friends) is pooled to generate such a domain-specific weighted characteristic tag list for the user. Preferably, each such weighted characteristic tag list of the component entities may be weighted, prior to pooling, via a factor related to a measure of affinity between the user and each entity. This measure may take the form of active weighting, ranking, and/or passive measures of affinity (like attention, number of views, clicks, downloads, etc.). Each user may be associated with such a domain-specific weighted characteristic tag list for each of one or more domains. Because they contain characteristics of preferred entities, these domain-specific weighted characteristic tag lists may potentially provide better matches to those specific domains than the user's weighted characteristic tag list.

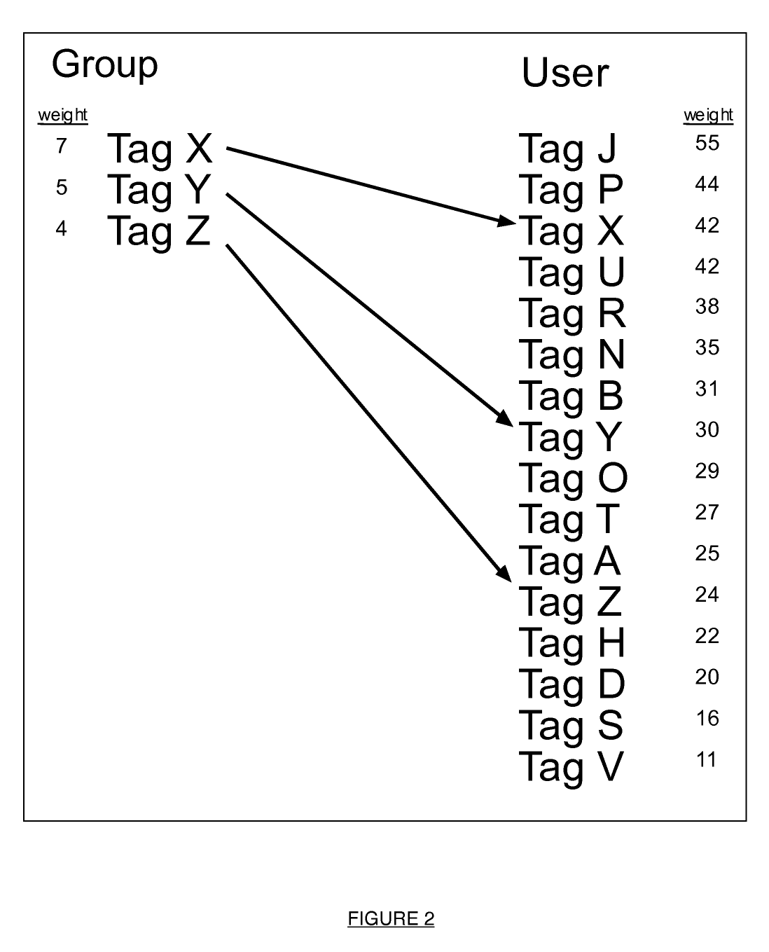

In a seventh variation, a group (with or without characteristic tags), which includes user-members who are associated with characteristic tags, may absorb (or assume/inherit) the pooled characteristic tag lists of the group members. As an example, visitors having characteristic tags browse to a webpage entity, and the webpage entity absorbs a small weight of all characteristic tags associated with the visitor, and a profile of visitors to the webpage can be established by compiling the absorbed associations of the webpage entities. As a second example, multiple tagged users with a declared interest in any entity or object (such as a song) may be assigning characteristic tags to that object by pooling of the characteristic tags of multiple users who listen to the song, read about the song, read about the band, or any other suitable related action that demonstrates affinity. The absorption of tags is preferably associated with at least one weighting factor, and may include multiple weighting factors based on the activity (such as a weight of 5 for listening to a song, and 8 for attending a concert, number of views, clicks, or any rating or ranking). As shown in FIG. 2, the characteristic tag lists compiled by such associations to define an entity may be a weighted list of characteristic tags. Both directions of definition may exist simultaneously, preferably as two weighted tag lists referring to each direction of the association (such as user to group or group to user).

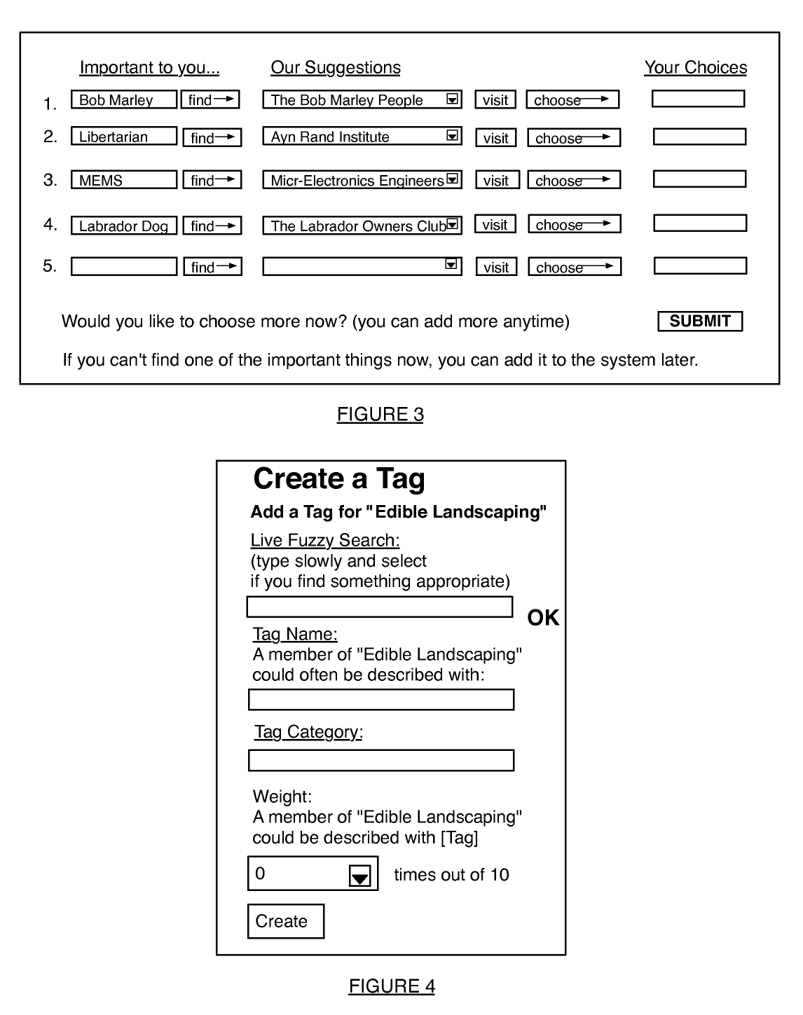

As shown in FIG. 3, a user may select a group with which user most identifies, based on the subject matter, images or description of the group. Once the user chooses the first group with which the user identifies, the user preferably chooses additional groups in the same way. The user preferably browses groups via a search feature or hierarchical index. A user preferably adds groups they identify with to an identification list and then preferably quantifies (more preferably in the same user interface) an identification score or weight that represents the level with which the user identifies with each group and its subject matter, preferably a number between 1 and 10. An identification list is a list of weighted groups associated with a user with which the user identifies and is preferably descriptive of the user's individuality or identity, and is preferably used directly and indirectly to calculate similarity scores between users and between users and groups and other entities, each of which is associated with a plurality of characteristic tags.

A characteristic tag list associated with an entity (such as a user characteristic tag list or a group characteristic tag list) may contain more than one of a given characteristic tag, since the same characteristic tag may be part of multiple reference entities' characteristic tag lists. Multiples of the same characteristic tag may be left alone or may be merged into the same or similar characteristic tags. If the characteristic tags are merged, the highest weighted characteristic tag in the characteristic tag list may be retained, or the weights may be averaged or even summed as a new single weighting factor. Multiples of the same characteristic tag may also be merged by taking a weighted average of the weights of the multiples, each weight further weighted by some measure of the contributing entity, preferably the entity's identification score or some other measure of affinity or importance.

As shown in FIG. 4, the characteristic tags associated with an entity are preferably selected by at least one entity, more preferably by a group of administrative users, but alternatively may be selected by all members of a group. As characteristic tags are entered, a suggestion feature preferably enables users to select characteristic tags among a pre-existing list of characteristic tags. If members are permitted to add characteristic tags, the suggestion feature may help to avoid duplications of existing characteristic tags or misspellings. If the entity is a group, the group may allow members the opportunity to participate collaboratively in the weighing of the characteristic tags for the group. Each group member may select a weight from a range, for example −10 to +10, where the average weight of that characteristic tag is stored for use in comparison calculations. Alternatively, this collaborative process may involve the weighted averaging of selected weights, with each selected weight further weighted by some measure of the selector, activity level, reputation, or merit points. A non-zero weight on a characteristic tag is preferably predictive (in a positive or negative fashion) of the type of entities that will have an affinity for a type of group, such as the type of users and/or members that a group will attract.

In an eighth variation, the characteristic tags may be ranked according to importance and/or a weight may be determined from the average ranking.

In a ninth variation, in order to help distinguish the meaning of the characteristic tag from other similar words, symbols or images, or similarly or identically-spelled characteristic tag names, a disambiguating word, symbol or image may also be added, which may also be called a category. For example, categories for “clean” reflect its diverse meanings, and could be relative to “dirt” or “drugs”, for example, depending on the context.

### 1.2 Generating a Comparison Matrix

Step S120, which recites generating a comparison matrix, functions to generate at least one comparison matrix for use in comparing at least two entities. The comparison matrix is preferably a matrix, but may alternatively be any sort of data structure, including a linked list, a tree, a hash table, or any other suitable data structure. The comparison matrix is preferably implemented in a SQL database table, but may be implemented in any other suitable fashion. A characteristic tag comparison matrix is preferably generated by comparing each characteristic tag in the weighted characteristic tag list of one of the entities with each characteristic tag in the weighted characteristic tag list of the other entity in a given entity-entity pair, more preferably, the characteristic tag comparison matrix is a global characteristic tag comparison matrix generated by comparing the set of all characteristic tags in all characteristic tag lists from all entities with itself.

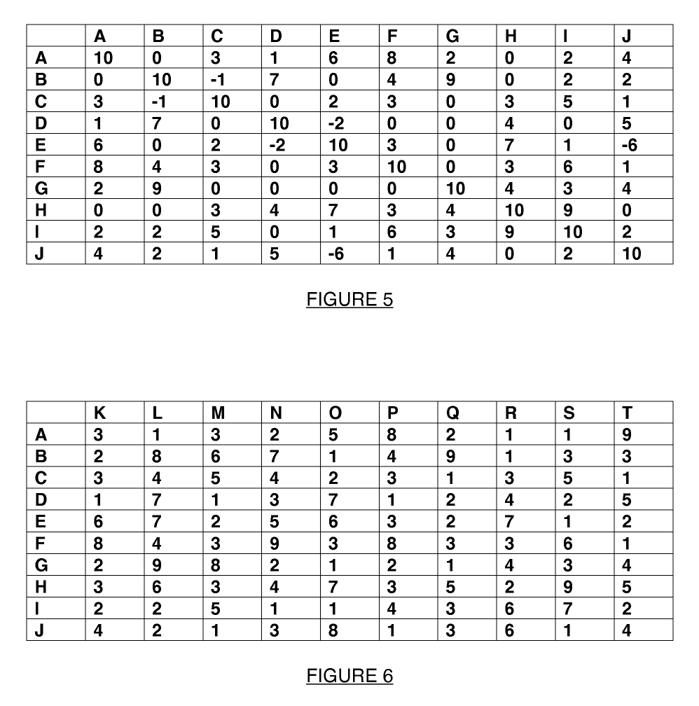

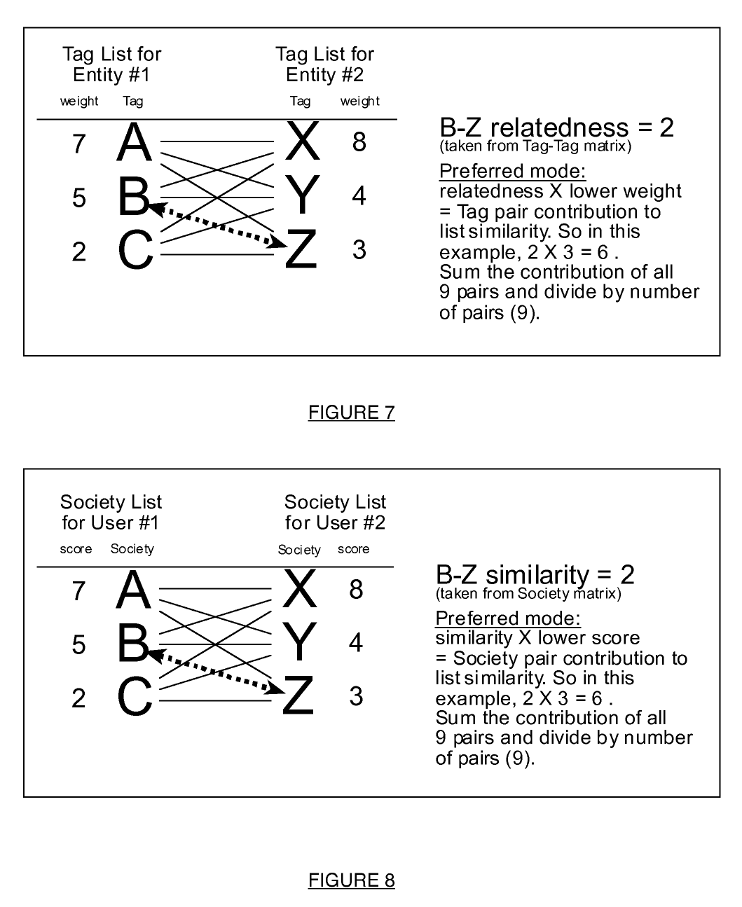

Step S120 preferably includes generating a characteristic tag comparison matrix, as shown in FIGS. 5 and 6. Each value in the characteristic tag comparison matrix is preferably a characteristic tag-characteristic tag pairwise relatedness value. The relatedness of two characteristic tags is preferably defined as the estimated likelihood that any entity accurately characterized by the first characteristic tag will also be accurately characterized by the second characteristic tag. Alternatively, relatedness may also refer to any other kind of semantic or functional relationship between the two characteristic tags. An individual characteristic tag weight factor may also weight each value in the characteristic tag comparison matrix. An entity characteristic tag list (such as a user characteristic tag list) can be used to quantify similarity to any other entity with a characteristic tag list. In the preferred method, all characteristic tag pairs (groups of two, one from each entity) of characteristic tags between any two entities are compared, and a score is produced for each pair based on the characteristic tag-characteristic tag relatedness score from the characteristic tag comparison matrix and/or characteristic tag weight. Those pair scores are preferably summed and/or divided by the number of pairs and/or the total number of characteristic tags, and/or other numeric adjustment (as shown, as a simplified example, in FIG. 7).

Step S120 further preferably includes generating an entity comparison matrix containing a similarity score of every entity pair calculated from the characteristic tag lists of each entity in the entity pair. Sample entity comparison matrices are shown in FIGS. 5 and 6, where entities in different pluralities are compared to each other (as shown in FIG. 5) and entities in the same plurality of entities are compared to each other (as shown in FIG. 6). Each entity comparison value is preferably calculated using characteristic tag lists from each entity to generate characteristic tag pairs (groups of two, one from each entity), and determining the tag pair similarities, more preferably from a global characteristic tag comparison matrix, which is preferably calculated using all characteristic tags from all groups, and preferably generated in the preferred method, and a similarity score for the entities is calculated from the tag pair similarity values, preferably by summing the values, and/or multiplying the similarity values by a weighting factor.

The similarity scores may be calculated in a number of approaches. In a first approach, the similarity between any two entities is preferably computed as the sum of the number of characteristic tags in common between the entities. If weighting factors are used, each common pair is preferably multiplied by the lower of the weights for the pair of common characteristic tags for each entity pair and the similarity scores are preferably stored in the entity comparison matrix.

In a second approach, as shown in FIG. 7, the entity-entity pairwise similarity scores are calculated using the characteristic tag matrix. Since each entity preferably maintains a list of weighted characteristic tags, and each of those characteristic tags is preferably related to every other characteristic tag (relatedness values of such relationships are preferably stored in the characteristic tag comparison matrix), the relationship between any two entities may be calculated in this fashion. User entities may initially be provided matches or recommendations based on similarity of a user's weighted characteristic tag list with the weighted characteristic tag lists of other entities. This may be entirely sufficient, but an option exists to allow users the ability to provide feedback which then modifies the matching or recommendation criteria by creating a separate weighted characteristic tag list used for providing future matches within a domain. Thus, in addition to their weighted characteristic tag list, users may also have multiple weighted characteristic tag lists, each for the purpose of providing matches in a different domain. Preferably, a user provides feedback through any standard rating system (for example, a choice of −3 to +3) that allows a user to quantify their affinity for an entity that was recommended (for example, a song). The weighted characteristic tag list of the entity that has been rated is either subtracted from or added to (depending on the rating) the user's weighted characteristic tag list. Prior to this, the weights of the weighted characteristic tag list of the entity may preferably be multiplied by the rating and also preferably a factor (like 0.1) to reduce the effect of such a subtraction or addition. Each subsequent rating by that user in that same domain continues to modify, in a similar fashion, that user's domain-specific weighted characteristic tag list, which may be used for predicting the user's affinity to entities within that domain (similarity calculation based on weighted characteristic tag lists is described in step S130).

In a third approach, an entity may be associated with a weighted list of other entities or reference entities (as with a user that has selected and weighted a plurality of groups). Since each of those reference entities is preferably related to every other reference entity (such relationships are recorded in an entity comparison matrix, such as a group-group comparison matrix), the relationship between any two entities that are associated with a weighted list of reference entities may be calculated in this fashion. An example calculation of user entity similarity using only reference entities is shown in FIG. 8. Here, the calculation (similar to the preferred method above) is performed on of all pairs (groups of two, one from each user) of reference entities (such as groups), involving preferably the product of the identification score for each pair (preferably the lower of the two identification scores) and the similarity score (taken preferably from the group-group comparison matrix), and a similarity score for the user entities is preferably calculated from the products, preferably by taking an average (summing the products and dividing by the number of reference entity pairs), and/or multiplying the products or average by a weighting factor, or some other mathematical operation.

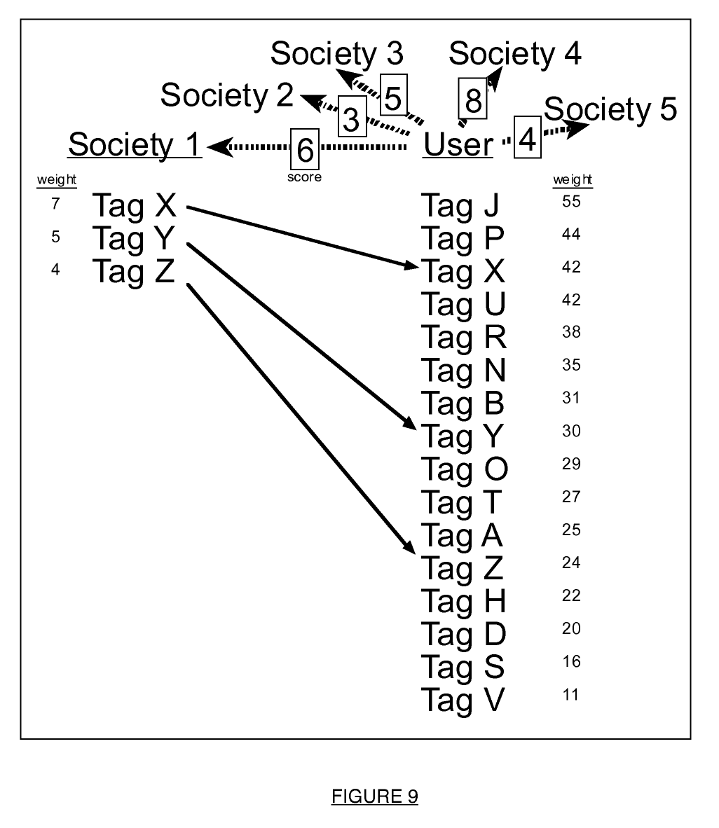

In a fourth approach, as exemplified in FIG. 9, an entity's list of weighted reference entities is converted into a larger list of weighted characteristic tags descriptive of the entity's individuality. This list preferably includes all the characteristic tags from all the entities in an entity's identification list or an entity characteristic tag list. Each such characteristic tag in the user characteristic tag list may be weighted by multiplying the identification score, of the entity associated with the characteristic tag, by the weight of the characteristic tag associated with the reference entity. This gives each user his/her own personal weighted user characteristic tag list, which can be used to quantify similarity with any other entity similarly tagged with weighted characteristic tags contained in the characteristic tag comparison matrix.

Step S120 may also include making a characteristic tag list of an entity more ‘unique’ by subtracting from it a characteristic tag list descriptive of a domain that the entity is a member. An entity may have a plurality of such subtracted lists, possibly one for each domain that the entity is a member, and those subtracted lists may be useful for predicting affinity with that entity. This is preferably achieved by a) creating a domain weighted characteristic tag list by pooling the weighted characteristic tag lists from some or all members of a given domain (for example: all bands, or all men, etc.), and then b) the weighted characteristic tags from a domain weighted characteristic tag list are subtracted from the weighted characteristic tag list of the specific entity (for example: a specific band, or a specific man, etc.), yielding a weighted characteristic tag list representing the ‘uniqueness’ of the entity. Preferably, such subtraction involves subtracting the weights (weights from the specific list minus weights from the domain list) from identical characteristic tags, and any characteristic tags in the domain characteristic tags list, but not in the specific characteristic tags list, are added to the new subtracted list with their values inverted (positive weights become negative, negative weights become positive). The characteristic tag weights in the specific characteristic tag list may also be converted to percentages. Each characteristic tag weight percentage of the general is subtracted from the specific characteristic tag list, resulting in a refined characteristic tag list. Further, characteristic tag lists may be normalized in their range such that the maximum weighted characteristic tag is 1.0 or 10 or 100, and subtracted as above. This may be preferable so as not to reduce the relative weights (especially of higher-weighted characteristic tags) of larger (in number or characteristic tags) characteristic tag lists.

In another variation, similarity scores between entities may be determined only if a plurality of entities are in physical proximity in the “real world” or a “virtual world”. Proximity may be determined through the use of any mobile-type device (using Bluetooth, GPS, signal triangulation, etc.). When a plurality of entities are in some physical proximity, a similarity determination is made on a device and/or through automated communication with a central server where the results of that determination may be sent back to the device. Should some predetermined level of similarity exist, at least one of those entities may be notified of any nearby similar entity, where such notification may include details of any nearby similar entity and even its distance and orientation from the notified entity. It may be predicted that more similar entities will tend to experience greater affinity between those entities.

Comparison matrices of entities may be used to generate hierarchical indexes or trees indicative of the similarity relationships of those entities. In a fashion similar to the way those in the field of bioinformatics may generate phylogenetic tree structures from distance matrices, an entity comparison matrix can be used to generate a hierarchical tree or index of such entities. A hierarchical index of entities (for example, a group index) can be created manually, but can also be generated automatically in this fashion. A hierarchical index of a plurality of characteristic tags may be generated, in a similar fashion, from a comparison matrix of a plurality of characteristic tags. Other plotting algorithms may be used to plot the location of entities in two or three-dimensional space such that the distance between each entity, or the distance between one entity and one or more other entities, is preferably related to the entity-entity similarity scores.

In generating the entity comparison matrix, the full n² calculation, where similarity scores between all entities, or any plurality of entities, are preferably determined at specific intervals. For example, such a calculation may take place once a day or week, or every time certain number of new entities has been added. The result of such calculations is preferably one or more entity comparison matrices, where the similarity scores are organized in such a way as to allow easy querying. Matrices need not show only an entity list compared with itself, as shown in FIG. 5. In one variation, to make the matrix smaller, users may be on one axis of the matrix, and the other axis would likely be users and/or groups. Another variation may split this matrix in two: one user-user matrix, and one user-group matrix. Yet another variation may split this matrix into a plurality of matrices where users may be on one axis of each matrix, and entities of a different domain are on the other axis of each matrix.

### 1.3 Determining a Similarity Score

Step S130, which recites determining a similarity score between the first entity and the second entity using the comparison matrix, functions to determine a similarity score between at least two entities. As exemplified in FIG. 7, determining the similarity of any two entities preferably includes the pairwise comparison value of the weighted characteristic tag lists of the entity pair. Each of the two characteristic tags being compared, a “characteristic tag pair”, has an existing relatedness score found at their juxtaposition in a characteristic tag comparison matrix, and the sum, product or average of all relatedness scores of all characteristic tag pairs between two entities preferably yields a entity-entity similarity score. The compilation of the characteristic tags from each entity is preferably weighted to allow finer tuning. The characteristic tags are preferably weighted by a weighting factor assigned to the entity, but may also or alternatively be weighted by weighting factors assigned to individual characteristic tags. Because each of a entity's characteristic tags are preferably weighted, each of a entity's characteristic tags is not necessarily equally important in the calculation, and each of the characteristic tags in a characteristic tag pair has likely been weighted differently by their respective entities, so the comparison of characteristic tags in a characteristic tag pair should also take into consideration the weight both entities assigned to those characteristic tags. The characteristic tag weight is preferably included in the calculation by using the sum, product or average of the two weights in the characteristic tag pair, or by using the lower of the two scores in the characteristic tag pair, as it is the lower of the scores that both characteristic tags have in common. Whether the method chosen is the sum, product, average or lower of the weights, or any other numeric method, this value is referred to as the weight factor. The characteristic tag-characteristic tag relatedness score may be multiplied by the weight factor, which yields the contribution of that characteristic tag-characteristic tag pair in the entity-entity similarity score. The entity-entity similarity score may be generated by summing the contribution for each characteristic tag-characteristic tag pair and dividing by the total number of characteristic tag-characteristic tag pairs or dividing by the number of total characteristic tags in both entities' lists. Alternatively, if the number of characteristic tag-characteristic tag pairs considered for each entity-entity pair is set and possibly limited to the highest-weighted set number of characteristic tags, say 10 for each entity, a simple sum, product or average may be sufficient.

In a first variation of step S130, the resulting characteristic tag comparison matrix of Step S120 is used, but it is required that the first entity and the second entity have characteristic tags in common in order to calculate a similarity score. However, two users who may share a number of highly similar characteristic tags may yet receive a low or zero similarity score, probably because the characteristic tags are not the same.

In a second variation of Step S130, the entity similarity score may be determined from a pre-computed entity comparison matrix computed in step S120. The result is that the pre-computed similarity scores between entities may be quickly retrieved from the entity comparison matrix to determine the similarity score between any entity and any other entity. This entity comparison matrix can be viewed as, or produce, an ordered list of entities, ordered by the scores of such calculations of similarity with a given entity, revealing the other entities most similar to the entity. In the case of user-user matching, the users may be likely suited for friendship and/or romantic relationships based on similarity between the matched users' attitudes, values, beliefs and personalities (preferably represented in a user's weighted characteristic tag list).

The calculations of similarity scores involve comparing large lists of characteristic tags or entities with large lists of characteristic tags and/or entities. This is often an n² complexity process, which suffers from performance issues for large values of n, which in this case could potentially be very large. Preferably, there are methods and shortcuts for reducing the computational complexity, for example by maintaining lists of entities (users, groups, etc.) that maintain, for example, characteristic tag ‘A’, or its top related characteristic tags, in their highest scoring characteristic tags. For example, when searching for entities with both ‘A’ and ‘B’ characteristic tags, the step may simply look for those entities found in both lists. The maintenance of lists of entities that identify strongly with one or more characteristic tags shifts the problem from computation (which becomes more linear) to memory, which is often a much easier and less expensive problem to solve.

Weighted characteristic tag matching (comparisons) preferably involve summing the lower weights of each characteristic tag pair in a comparison, and then dividing by either the number of pairs or the number of characteristic tags involved in the comparison. Complexity of a pairwise comparison of weighted lists of characteristic tags or entities increases with the length of those lists. In one variation, the number of characteristic tags used in the comparison is limited for each tagged entity, for example only the top 20 highest weighted characteristic tags would be used for entities such as users and groups, and possibly only 5 or 10 would be used for things like external websites, music, videos, products, etc. preferably, the length of weighted entity or reference entity lists is limited for the purpose of calculations. Standardizing the length of weighted lists used in a comparison would eliminate the need to divide the sum by the number of pairs or characteristic tags and/or entities involved in the comparison. These limited number of characteristic tags may also be subsequent to a subtraction of a domain weighted characteristic tag lists, as described above, which will result in a re-sorting of the characteristic tags, so more characteristic tags unique to the particular entity rise to the top. Additionally, the total number of characteristic tags available for association with an entity may be limited as well.

In another variation, entity-entity (such as user-user, or user-group) matching may be done more efficiently by allowing the smaller list of weighted group choices of the user to be used in calculations. Entity-entity similarity scores may be taken from a similarity matrix where an entity's weighted characteristic tags are compared to another entity's weighted characteristic tags using methods described above. Since this is a relatively static matrix, regenerated and updated only at certain intervals, the full weighted characteristic tag lists may be used, or perhaps a fixed number of characteristic tags, such as the top 20 characteristic tags, which may or may not have undergone a ‘uniqueness’ subtraction. Additionally, the number of weighted reference entities included in a matching computation for a user may be limited to the top 5 or 10. As above, standardizing the number of weighted lists used in a comparison would eliminate the need to divide the sum by the number of pairs or characteristic tags/entities involved in the comparison.

The method may include mathematical algorithms for the analysis of massive datasets that would be created by the above steps. Such algorithms may include: algorithms for sparse and dense matrices, eigenvectors (for example, of weighted link matrices), various techniques and algorithms from the field of bioinformatics, hashes and shingles, Fourier transform and Tree Edit Distance algorithms, bipartite matching (for example, using linear programming), vertex covers, fast sorting algorithms, adjacency matrices or lists (possibly via certain decomposition techniques), spanning trees, principal component analysis, matrix decompositions, discounted cumulated gain optimization, distance-based clustering, nearest neighbor searching (for example, by locality-sensitive hashing), latent semantic analysis, tensor-based data applications, adaptive discriminant analysis, or any other suitable algorithms.

### 2. Method of Generating a Color Representation of an Entity

As shown in FIGS. 10-11, a second preferred embodiment of the invention includes a method 200 of generating a visual representation of a first entity. The method 200 includes associating the entity with a first reference entity that is associated with a first plurality of characteristic tags S210, associating the entity with a second reference entity that is associated with a second plurality of characteristic tags S220, and generating a color representation of the entity from the first plurality of characteristic tags and the second plurality of characteristic tags S230. The color representations of entities are preferably used to signify the particular affinities of an entity, enabling a user or group to estimate their affinity with that particular entity from a visual inspection.

Step S210, which recites associating the entity with a first reference entity, functions to associate an entity with the characteristic tags of a reference entity that has been previously described by a plurality of characteristic tags. Similarly, Step S220, which recites associating the entity with a second reference entity, functions to associate an entity with the characteristic tags of another reference entity that has been previously described by another plurality of characteristic tags.

Step S230, which recites generating a color representation of the entity from the first plurality of characteristic tags and the second plurality of characteristic tags, functions to determine a color representation of the first entity. This is preferably accomplished by using associated values from additional reference entities, such as a generating a color representation from the combined tag lists of all reference entities on an entity identification list or from other entities with an affinity for the reference entity. This may alternatively be accomplished by generating a color representation for each reference entity, and combining the resulting colors into a single multicolor representation. This multicolor representation may use the similarity scores or weights assigned to other entities to affect the size, width, thickness, brightness or any other suitable parameters. Furthermore, the resulting colors may be combined through an average of their numerical color values (such as HSV, HSL, RGB, and CMYK values) or through any other suitable method to combine colors. In one variation, the third color representation is a weighted average of numerical color values of the first color representation and numerical color values of the second color representation. In another variation, the similarity score of the first entity relative to other reference entities (such as a user to a group or a group to a group) determines the relative location of third color representation on the color wheel.

Since each reference entity is preferably associated with a color, and each entity is preferably associated with a weighted list of reference entities with which it identifies, the result is that each entity may have a set of colors of different sizes, where the size is relative to each similarity or identification score between the entity and the reference entity. The reference entities are preferably displayed in units of color (such as HS colors), with their size proportional to the entity's similarity or identification score for each reference entity. As an example, the display may include colored circles of various sizes or adjoining colored bars of various widths or thickness, as shown in FIG. 11. The brightness and/or tint of colors may also be used to represent the entity's identification score for each reference entity. Such an entity color set can be displayed online, printed on cards, bumper stickers, shirts, etc.

In addition to their user color set, in one variation, an entity may also be assigned a single color. This can be achieved in any number of ways using color theory. For example, HSV colors of the user color set can be mixed via “additive color mixing”. Alternatively, splitting the axes and treating each separately can generate the color: saturations added (until the max) or averaged, values added (until the max), hues added or averaged in a 3600 color wheel (where greater than 3600 wraps). The color may have an existing designation and even a name, which can be provided by the entity. The color may also be displayed online, printed on cards, bumper stickers, shirts, etc.

In another variation, the entity's color set and/or user characteristic tag list may be displayed on a website, or home page, of the entity. For example, each characteristic tag on the entity's home page is preferably clickable and linked to similarly tagged entities and, more preferably, ranked or sorted by the weight of that characteristic tag. Additionally, an entity may use the user color set, by clicking on each color square/bar/circle, which may be linked to the reference entity associated with that color. The entity color set is preferably a convenient means of organizing a entity's various reference entities, monitoring the activity of those reference entities, and visiting new or archived content, plus other entities associated with any of the entity's associated reference entities. As an example, hovering the cursor over a characteristic tag or one of the entity color set may reveal a popup information display, or a drop-down, multi-branch linked menu of the entity's associated reference entities, current activities and other entities that share those characteristic tags and colors.

In yet another variation, an entity is preferably either required to choose a color, or assigned a color. A color is preferably chosen by an entity administrator by using an interactive feature, such as a java applet or other interactive graphical web technology, the feature being similar to a Zooming User Interface (ZUI). The feature may involve moving a small window over a larger square grid of colors (possibly HS color space), where the region in the window can be expanded to the entire square, and this process can be continued until the smallest pixelation of color space is visible. Entity administrators may select a square, and the name of the color is displayed (if a name exists, otherwise a color code), and also any other entity associated with the color under the cursor can be displayed, or if the color is available this can also be indicated. Entity administrators may choose to see only those colors that are available and not already assigned to reference entities. Entity administrators may enter the name of a similar reference entity, and the feature can display the zoomed square of color with the similar entity in the center, display the available colors in that square, choose a color near the similar entity by clicking on the color of choice. Alternatively, the entity administrators can find a region or color for their new entity by entering one or more tags, and the color square preferably shows locations indicative of the reference entities associated with those tags. This preferably aids an entity administrator in locating regions/colors where those tags are more common and thus may be a more appropriate region.

### 3. Method of Relating Characteristic Tags

As shown in FIGS. 12-15, a third embodiment of the invention includes a method 300 for determining relationships between characteristic tags of an entity or group and other characteristic tags associated with other entities or reference entities. As shown in FIG. 12 the method 300 of relating characteristic tags includes selecting a first characteristic tag from a first plurality of characteristic tags S310, selecting a second characteristic tag from a second plurality of characteristic tags S320, relating the first characteristic tag and the second characteristic tag S330.

Step S310, which recites selecting a first characteristic tag from a first plurality of characteristic tags, functions to select a characteristic tag to be related to another characteristic tag, while Step S320, which recites selecting a second characteristic tag from a second plurality of characteristic tags, functions to select a characteristic tag to be related to the first characteristic tag.

Step S330, which recites relating the first characteristic tag and the second characteristic tag, preferably functions to generate a characteristic tag—characteristic tag relatedness score. Just as each characteristic tag is related to an entity or group by a weight, so too are characteristic tags related to each other by weights. Such relatedness scores constitute the values of the characteristic tag comparison matrix. In one variation, the relatedness between the same characteristic tag pair may be determined by multiple members or groups in collaboration, where each score acts as a vote. In this variation the final relatedness score may be an average, or a weighted average, of the votes. For a weighted average, weights are preferably determined by some measure, for example the size or activity of the group from where the score comes. In a second variation, one or more separate characteristic tag comparison matrices containing information on the relatedness of characteristic tags as they are used and related within specific domains of groups or entities may also be generated. A separate characteristic tag comparison matrix may be generated for each domain. These matrices may reveal useful semantic usage data.

As shown in FIG. 13, positive relationships between characteristic tags are preferably assigned a weight between +1 (for minimally positive relationship) and +10 (for maximally positive relationship), and negative relationships between characteristic tags may be assigned a weight between −1 (for minimally negative relationship) and −10 (for maximally negative relationship). Those characteristic tags that have been considered and not selected as related to a given characteristic tag may be assumed to be unrelated or neutral, and therefore preferably assigned a characteristic tag-characteristic tag weight of 0. This weight of 0, as a result of a non-selection, is preferably assigned a fractional vote such that it does not influence the final weight as much as a full vote. Every time a characteristic tag is not selected, the vote fraction increases until some number of non-selections equals a full vote of 0. An entity may replace its characteristic tag-characteristic tag weight of 0 with a non-zero weight at any time. In other variations, a zero vote may be allowed and, in further variations, even encouraged. These semantic associations preferably result in a dense matrix of characteristic tag-characteristic tag relationships (the “characteristic tag comparison matrix”).

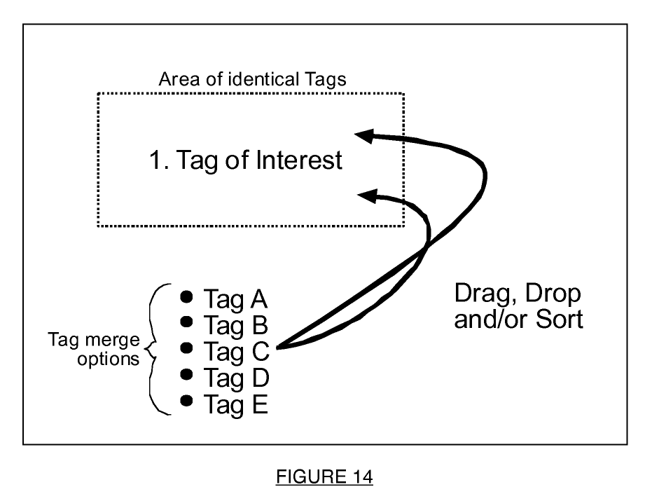

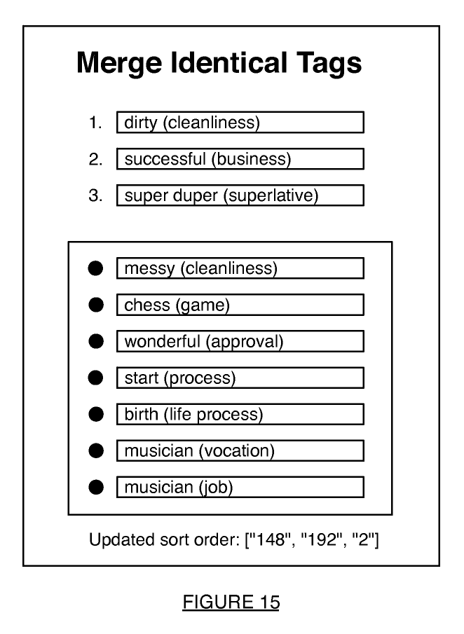

The method 300 may also include steps to reduce the number of characteristic tags of identical (or highly similar) meaning by removing the duplicate characteristic tags and leaving only one characteristic tag of that meaning. As shown in FIG. 14, an interface for merging tags allows ranking the elements, preferably using the JavaScript sortable elements from the Scriptaculous library, or other similar client script. The interface preferably includes a recently added characteristic tag in one box and all the potentially identical characteristic tags in another box. Members preferably drag identical (or highly similar) characteristic tags from the “potentials” box and drop them into the box containing the just-added characteristic tag. The order that the characteristic tags are dropped, whether above or below the just-added characteristic tag, or the order that the characteristic tags in that box are ultimately sorted, reveals both the group of identical characteristic tags, and the member preference indicating the top characteristic tag as the remaining characteristic tag. The resulting rank ordered list is preferably used in calculations or the top characteristic tag or several top characteristic tags may be used. Using this method, the last column might be the sum of the position differences between the two characteristic tags in the sortable box. For example, if characteristic tag A is ranked above characteristic tag B twice, by 2 positions and 3 positions, and characteristic tag B is ranked above characteristic tag A once, by 1 position, and once characteristic tag A and characteristic tag B were not selected as identical, then the number of “yes” votes is 3, the number of “no” votes is 1, and the position column is 4 (2+3−1). This data would indicate that, so far, members tend to think characteristic tag A and characteristic tag B are identical, and that characteristic tag A is preferred between the two.

A merge process may first act on the merge table, where all instances of the removed characteristic tag are replaced by the remaining (preferred) characteristic tag. This may cause a cascade effect where the replacing of characteristic tags in the affected rows may cause two rows to refer to the same characteristic tag A and characteristic tag B pair, summing the vote and position data, which may trigger a secondary merge process, etc. Should two characteristic tag pairs trigger a merge at the same time, the order of merge preferably involves the position column, where a calculation like the absolute value of the position sum column divided by the number of yes votes determines the merge order. The votes may be used to determine characteristic tag weights or tag weight relationships. A merge process may be triggered if the number of yes votes exceeds the number of no votes by a certain number and/or percent, for example if the number of yes votes simply exceeds the number of no votes by 10 votes. One way to achieve this is to have a database “merge” table where rows contain the ids for each pair of characteristic tags selected as being identical (not necessarily including the just-added characteristic tag, but all pairs of characteristic tags selected). The table row may include the number of yes votes, the number of no votes, and possibly another column indicating which of the two characteristic tags is preferred to remain. The merge process also may cause a cascade of changes throughout all the other tables in the database that involve characteristic tags and their id's, where duplicate rows may result, requiring those rows to merge as well.

The method of the third preferred embodiment may also include Step S340 (not shown), which recites repeating steps S310, S320 and S330 to generate a characteristic tag comparison matrix. The generated characteristic tag comparison matrix, which relates characteristic tags from the first plurality of characteristic tags to characteristic tags from the second plurality of characteristic tags, enables an accurate computation of the similarity between entities based on their characteristic tags. In terms of database formats (for example, with Ruby on Rails), this can be achieved with, for example, self-referential characteristic tag-characteristic tag associations with extra information (for example, weight and number of votes) in the “join table”. The join table preferably includes columns consisting of an id, the id of characteristic tag A, the id or characteristic tag B, the weight, the number of votes. The id of the characteristic tags refers to the entries in a separate characteristic tag table describing each characteristic tag. The method may further include the generation of a table keeping track of characteristic tag-characteristic tag weights within each group, and/or a global characteristic tag-characteristic tag join table. In either case, an index on the id's of both characteristic tags is preferably created for fast access. In the case of a join table that includes the group id, that too would preferably be included in the index, probably in first position such that the characteristic tag-characteristic tag relationships of a specific entity could be more efficiently found (this indexing format is a feature of certain databases, such as MySQL).

In one variation, a database keeps track of directionality of characteristic tag-characteristic tag relationships. For example, if someone is a “geek” they are likely also “smart”, but the opposite is less likely to be true as “smart” does not as strongly imply “geek”. This directionality may be reflected in the order of characteristic tag id columns listed in the database tables discussed above. Preferably characteristic tag-characteristic tag relationships are recorded in both directions.

In another variation, which does not require manually determining semantic or functional relatedness, includes inferring that if two characteristic tags are present in the same characteristic tag list, that there is a relationship there, even if it is not purely semantic in nature. Characteristic tag—characteristic tag weights may be simulated by taking a count or frequency of finding characteristic tag A and characteristic tag B in the same entity characteristic tag list versus finding characteristic tag A without characteristic tag B, or characteristic tag B without characteristic tag A (for directionality).

As a person skilled in the art will recognize from the previous detailed description and from the figures and claims, modifications and changes can be made to the preferred embodiments of the invention without departing from the scope of this invention defined in the following claims.

I Claim:

1. A method of predicting affinity between a first entity and a second entity, comprising:
associating a first plurality of characteristic tags with the first entity, wherein the first plurality of characteristic tags are associated with a first reference entity;
generating a comparison matrix; and
determining a similarity score between the first entity and the second entity using the comparison matrix, wherein the second entity is associated with a second plurality of characteristic tags.

2. The method of claim 1, further comprising associating the first entity with a third plurality of characteristic tags, wherein the third plurality of characteristic tags are associated with a second reference entity.

3. The method of claim 1, wherein the step of generating a comparison matrix includes determining characteristic tag comparison values for a characteristic tag comparison matrix by comparing each characteristic tag in a third plurality of characteristic tags with each characteristic tag in a fourth plurality of characteristic tags, wherein the third plurality of characteristic tags includes the first plurality of characteristic tags, and wherein the fourth plurality of characteristic tags includes the second plurality of characteristic tags.

4. The method of claim 3, wherein the third plurality of characteristic tags is identical to the fourth plurality of characteristic tags.

5. The method of claim 3, wherein the step of determining a similarity score between the first entity and the second entity using the comparison matrix includes calculating the similarity score using the characteristic tag comparison values in the characteristic tag comparison matrix which correspond to the first plurality of characteristic tags compared to the second plurality of characteristic tags.

6. The method of claim 3, wherein each characteristic tag in each plurality of characteristic tags associated with an entity is multiplied by an individual characteristic tag weight factor.

7. The method of claim 3, further comprising receiving entity votes, wherein each tag in the first plurality of characteristic tags is assigned a first weighting factor and the second plurality of characteristic tags is assigned a second weighting factor and wherein at least one of the weighting factors is based on the entity votes.

8. The method of claim 1, wherein the step of generating a comparison matrix includes determining entity similarity scores for an entity comparison matrix by calculating a similarity score between each entity in a first plurality of entities and each entity in a second plurality of entities, and wherein the first plurality of entities includes the first entity and the second plurality of entities includes the second entity.

9. The method of claim 8, wherein the first plurality of entities and the second plurality of entities are the same plurality of entities.

10. The method of claim 8, wherein the step of determining a similarity score between the first entity and the second entity using the comparison matrix includes selecting the comparison score from the comparison matrix, wherein the entity similarity score between the first entity and the second entity is selected from the entity comparison matrix, wherein the entity comparison matrix includes entity similarity scores determined from characteristic tag comparison values in a characteristic tag comparison matrix which correspond to a first plurality of characteristic tags associated with the first entity compared to a second plurality of characteristic tags associated with the second entity.

11. The method of claim 1, wherein the first entity and the second entity are a pair of entities selected from the group consisting of: the first entity is a user and the second entity is a user, the first entity is a user and the second entity is a group, and the first entity is a group and the second entity is a group.

12. The method of claim 1, wherein the step of associating a first plurality of characteristic tags with the first entity includes creating a new entity to use as the first entity and selecting a first reference entity.

13. The method of claim 12, wherein each tag in the first plurality of characteristic tags is weighted by a weighting factor associated with the first reference entity, wherein the weighting factor relates the first entity to the first reference entity.

14. The method of claim 1, wherein the step of associating a first plurality of characteristic tags with the first entity includes passively associating the characteristic tags from a reference entity with the first entity.

15. A method of relating characteristic tags, comprising:
a) selecting a first characteristic tag from a first plurality of characteristic tags;
b) selecting a second characteristic tag from a second plurality of characteristic tags; and
c) relating the first characteristic tag and the second characteristic tag.

16. The method of claim 15, wherein step c) includes determining a semantic relationship between the tags.

17. The method of claim 15, wherein step c) includes assigning a weighting factor to the relationship between the first characteristic tag and the second characteristic tag.

18. The method of claim 15, wherein step c) includes selecting a third characteristic tag from a third plurality of characteristic tags and ranking the first relationship between the first characteristic tag and the second characteristic tag and the second relationship between the first characteristic tag and the third characteristic tag.

19. The method of claim 15, further comprising:
d) repeating steps a), b), and c) to generate a characteristic tag comparison matrix, wherein the characteristic tag comparison matrix relates characteristic tags from the first plurality of characteristic tags to characteristic tags from the second plurality of characteristic tags.

20. A method of generating a color representation of an entity, comprising:
associating the entity with a first reference entity, wherein the first reference entity is associated with a first plurality of characteristic tags;
associating the entity with a second reference entity, wherein the second reference entity is associated with a second plurality of characteristic tags; and
generating a color representation of the entity from the first plurality of characteristic tags and the second plurality of characteristic tags.

21. The method of claim 20, wherein the step of generating a color representation of the entity from the first plurality of characteristic tags and the second plurality of characteristic tags further comprises the sub-steps of:
generating a third plurality of characteristic tags from the first plurality of characteristic tags and the second plurality of characteristic tags; and
generating a color representation from the third plurality of characteristic tags.

22. The method of claim 20, wherein the step of generating a color representation of the entity from the first plurality of characteristic tags and the second plurality of characteristic tags further comprises the sub-steps of:
generating a first color representation of the first reference entity from the first plurality of characteristic tags, and creating a second color representation of the second reference entity from the second plurality of characteristic tags; and
generating a third color representation from the first color representation and the second color representation.

23. The method of claim 22, wherein third color representation is a weighted average of numerical color values of the first color representation and numerical color values of the second color representation.

24. The method of claim 22, wherein the third color representation includes a display area of the first color representation and a display area of the second color representation, wherein the display area of the first color representation is sized corresponding to a similarity score relating the entity to the first reference entity, and wherein the display area of the second color representation is sized corresponding to a similarity score relating the first entity to the second reference entity.

25. The method of claim 22, wherein the third color representation is selected from a color wheel, wherein the relative location of third color representation on the color wheel is relative to the first color representation and is determined by the similarity score of the first entity to the second entity and wherein the relative location of third color representation on the color wheel is relative to the first color representation is determined by the similarity score of the first entity to the second reference entity, and the entity is associated with a third plurality of characteristic tags, and the similarity score between the entity and the first reference entity is calculated using a characteristic tag comparison matrix generated from the third plurality of characteristic tags and the first plurality of characteristic tags, and wherein the similarity score between the entity and the second reference entity is calculated using a characteristic tag comparison matrix generated from the third plurality of characteristic tags and the second plurality of characteristic tags.
